(19) United States
(12) Patent Application Publication
(10) Pub. No.: US 2014/0090004 A1
(43) Pub. Date: Mar. 27, 2014

(54) Antenna System and Installation for High Volume Television Capture

(71) Applicant: AEREO, INC., Long Island City, NY (US)

(72) Inventors: Joseph Thaddeus Lipowski, Norwell, MA (US); Chaitanya Kanojia, West Newton, MA (US); John David Cann, Brooklyn, NY (US); Brian Scott Loveland, Southborough, MA (US); James Alan Bingham, Westerville, OH (US); Stephen Edward Harris, Columbus, OH (US)

(73) Assignee: AEREO, INC., Long Island City, NY (US)

(21) Appl. No.: 13/626,588

(22) Filed: Sep. 25, 2012

(51) Int. Cl. H04N 21/61

(52) U.S. Cl. CPC H04N 21/6156
USPC 725/127; 29/601

(57) ABSTRACT

An installation includes one or more card cages, which hold antenna array cards for capturing over the air content. The one or more card cages are installed at a cage site, such as a shelter located on the roof of a structure or a floor within the structure. The card cages are powered by a power supply, which is housed within a power supply site. The power supply site is typically a shelter on the roof of the structure or the floor within the structure.

### BACKGROUND OF THE INVENTION

Recently, systems including arrays of small radio frequency (RF) antennas have been used for capturing over the air content, such as broadcast television. The systems then stream the content to users via a public network, such as the Internet. An example of a system for capturing and streaming over the air content to users via the Internet is described in, “System and Method for Providing Network Access to Antenna Feeds” by Kanojia et al., filed Nov. 17, 2011, U.S. patent application Ser. No. 13/299,186, (U.S. Pat. Pub. No. US 2012/0127374 A1), which is incorporated herein by reference in its entirety.

In the typical capture system, each user has their own antenna. Thus, the systems are designed to include arrays having large numbers of small antennas. In order to maximize the number of antennas at the installation location, the arrays are preferably deployed in three dimensional arrays. The three dimensional arrays are created by implementing two dimensional arrays on antenna array cards, and then installing multiple antenna array cards in close proximity to create the three dimensional arrays.

### SUMMARY OF THE INVENTION

Because the antennas are physically small and the arrays are preferably dense, the systems should be located physically near to the television transmitters. This ensures a strong signal that compensates for the low gain characteristics of the small antennas and any other attenuation effects due to the density of the arrays.

Locating the antenna systems near the transmitters often means locating the systems in areas of high population density, which places restrictions on the size and configuration of the system installation. Generally, the installation location is a building or structure that is able to house the antenna systems on the roof of the structure or within one of the floors of the structure.

In general, according to one aspect, the invention features an installation for high volume television broadcast capture. The installation includes one or more card cages, each holding antenna array cards that capture television broadcasts transmitted by one or more broadcasting entities. The installation further includes a cage site for protecting the one or more card cages and a structure supporting the cage site with the one or more card cages having a line of sight to one or more transmitters of the one or more broadcasting entities.

In general, according to another aspect, the invention features a capture and distribution system. The system includes a capture and demodulation subsystem that captures over the air content and demodulates the captured over the air content into content transmission data. The system further includes a transcode subsystem to transcode the content transmission data. Additionally, the system includes a cloud system implementing a storage, streaming, and web subsystem to store the transcoded content transmission data and stream the transcoded content transmission data to client devices as content data and a data connection to send the transcoded content transmission data to the storage, streaming, and web subsystem.

In general, according to another aspect, the invention features an antenna array card. The antenna array card includes an antenna array for capturing over the air content. The antenna array card further includes a tuner and demodulator section for tuning antenna elements of the antenna array and then demodulating the over the air content captured by the antenna array into content transmission data and a transcode section for transcoding the demodulated content transmission data.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a hybrid block and schematic perspective diagram of an installation for high volume television broadcast capture.

FIG. 2 is a hybrid block and schematic perspective diagram of an alternative installation for high volume television broadcast capture.

FIG. 3 is a schematic perspective view of a card cage structure shown in phantom, which functions as an enclosure for the antenna array cards to create a three dimensional antenna array.

FIG. 4 is a block diagram illustrating a system for the capture and distribution of over the air content.

FIG. 5 is a block diagram illustrating how the capture and demodulation subsystem, transcode and indexer subsystem, and storage, streaming, and web subsystem are distributed about the installations described in FIGS. 1 and 2.

FIG. 6 is a hybrid block and schematic perspective diagram of an alternative installation for high volume television broadcast capture that further includes a cloud services site.

FIG. 7 is a block diagram illustrating how the capture and demodulation subsystem, transcode and indexer subsystem, and storage, streaming, and web subsystem are distributed about the installation and the cloud services site described in FIG. 6.

FIG. 8 is a block diagram illustrating an alternative embodiment of how the capture and demodulation subsystem, transcode and indexer subsystem, and storage, streaming, and web subsystem are distributed about the installation and the cloud services site described in FIG. 6.

FIG. 9 is a block diagram of an alternative antenna array card.

### DETAILED DESCRIPTION OF THE PREFERRED EMBODIMENTS

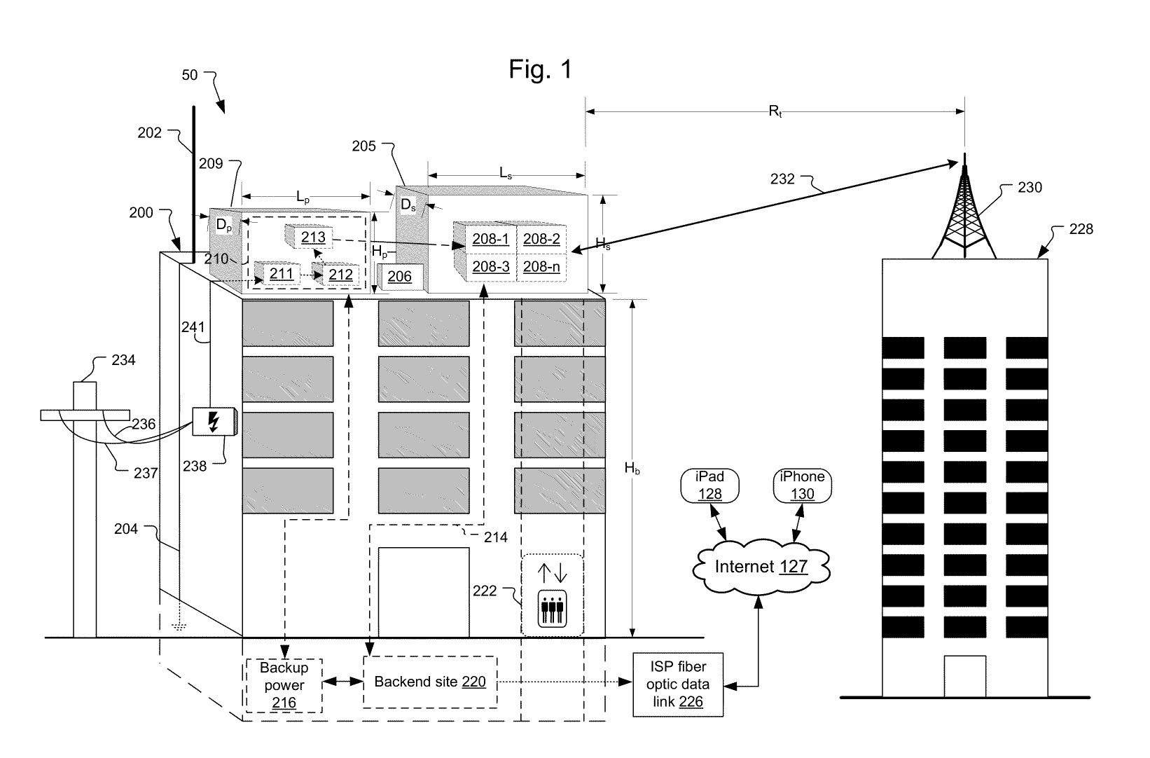

FIG. 1 is a hybrid block and schematic perspective diagram of an installation 50 for a system for the capture and distribution of over the air content 100, which has been constructed according to the principals of the present invention.

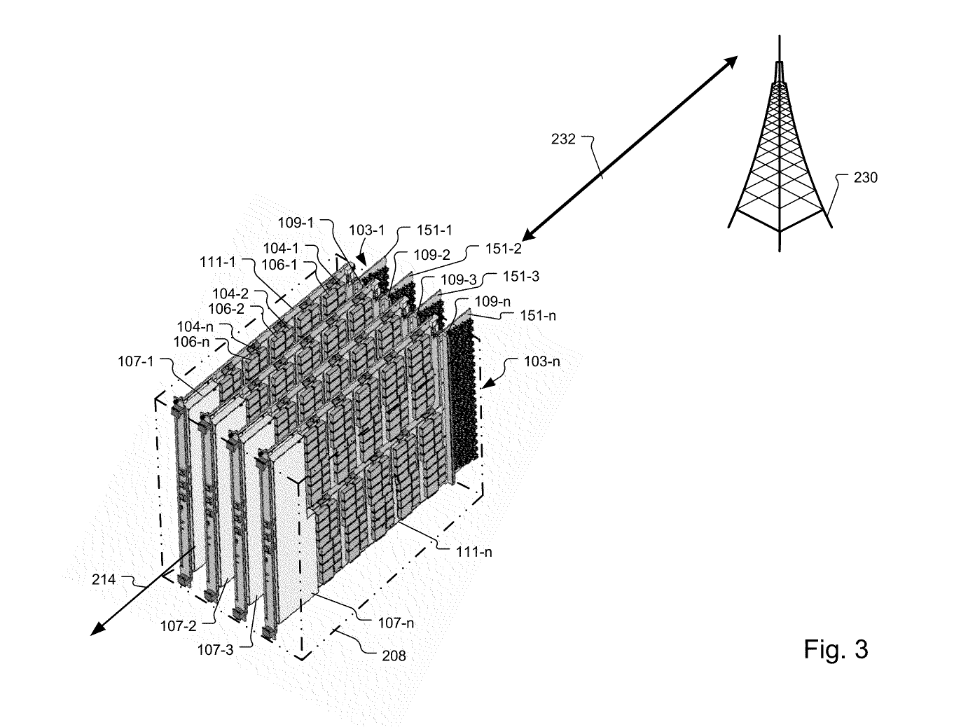

In general, the installation 50 comprises one or more card cages 208-1 to 208-n that hold antenna array cards (e.g., reference numerals 151-1 to 151-n in FIG. 3) for capturing over the air content, such as broadcast television transmitted by one or more television transmitters 230 operated by broadcasting entities in the system for the capture and distribution of over the air content 100. The one or more card cages 208-1 to 208-n are installed at a cage site 205, which is typically a shelter that protects the one or more card cages. A structure 200 such as a building supports the cage site 205 that houses the one or more card cages 208-1 to 208-n.

In the illustrated embodiment, the one or more card cages 208-1 to 208-n provide mechanical support and protection for the antenna array cards 151-1 to 151-n that are housed within the card cages 208-1 to 208-n. In a typical implementation, each card cage 208-1 to 208-n holds between 8 and 32 antenna array cards. However, greater or fewer antenna array cards 151-n to 151-n may be housed within the card cages 208-1 to 208-n.

A typical installation often includes at least 10 card cages 208-1 to 208-n, but the number of card cages 208-1 to 208-n at an installation location could be larger or smaller based on the space available at the installation. For example, it is common to have twenty or more card cages 208-1 to 208-n in an installation location. In a preferred embodiment, the card cages 208-1 to 208-n are arranged within the installation such that the fronts of the card cages 208-1 to 208-n maintain a line of sight 232 to the one or more transmitters 230 of the one or more broadcasting entities.

The one or more television transmitters 230 are typically installed on transmitter building 228. Alternatively, the television transmitter 230 could also be a transmission tower (or TV mast). The one or more television transmitters 230 are typically operated by broadcasting entities such as The American Broadcasting Company (ABC), The National Broadcasting Company (NBC), or CBS broadcasting corporation (CBS), to list a few examples.

The cage site 205 is a box-like shelter installed on a roof of the structure 200. The cage site 205 protects the card cages 208-1 to 208-n from the weather and the elements. Because the cage site 205 is installed outdoors, the card cages 208-1 to 208-n (and antenna array cards 151-n to 151-n within the card cages) should be relatively robust against temperature cycling that would be associated with an outdoor location.

In a preferred embodiment, a front side of the cage site 205 has a length Lₛ (length of the cage site) that is at least five meters. Additionally, the cage site also has a depth Dₛ (depth of the cage site) and height Hₛ (height of the cage site) of at least three meters. These dimensions for the cage site 205 are based on a preferred embodiment. However, the dimensions of the cage site 205 could be larger or smaller depending on the number card cages 208-1 to 208-n installed at the cage site 205, any building/zoning restrictions, or the space available at the installation location, to list a few examples.

In the preferred embodiment, the font side (or wall) of the cage site 205 (i.e., the five meter long Lₛ side) faces the one or more television transmitters 230 of the broadcasting entities. Facing the font side of cage site 205 enables the largest number of card cages 208-1 to 208-n (and antenna array cards) to have the line of sight 232 with the one or more television transmitters 230. Preferably, the front wall of the cage site 205 is constructed from nonmetallic, nonconductive, and/or non RF attenuating materials to ensure that that front wall does not interfere with radio frequency signals broadcast from the one or more television transmitters 230.

In a preferred embodiment, a range Rₜ (range to television transmitter) from the structure 200 to the one or more television transmitters 230 is typically less than 10 miles (16 kilometers). This range is based on an estimate of the strength of a broadcast signal at the installation location. However, the actual strength of the broadcast signal may be affected by factors such as terrain, bodies of water, surrounding buildings, and weather, to list a few examples. Thus, the installation 50 may need be located closer. Alternatively, the installation may also be located farther than 10 miles from the one or more television transmitters if the broadcast signal is strong enough at the installation location.

The installation 50 includes a cooling system 206 to remove excess heat from the cage site 205. In the illustrated embodiment, the cooling system 206 is located on the roof of the structure 200 near the cage site 205. The cooling system 206 is often an air conditioning or a chiller system. Additionally, the cooling system 206 often utilizes exhaust fans to remove heat from the cage site 205.

The installation 50 further includes a power supply site 209 that houses a power supply 210. In the illustrated embodiment, the power supply site 209 is a box-like shelter located on the roof of the structure. The power supply site protects the power supply 210 from the weather and elements.

In a preferred embodiment, the power supply site 209 has a length Lₚ (length of power supply site), depth Dₚ (depth of power supply site), and height Hₚ (height of the power supply site) of at least two meters. The dimensions of the power supply site 209 are based on a preferred embodiment of the power supply site 209. However, the dimensions of the power supply site 209 could be larger or smaller depending on the size of the power supply 210, the space available at the installation location, or building restrictions, to list a few examples.

The power supply 210 of the installation 50 typically includes a step-down transformer 211, an AC/DC (alternating current to direct current) converter 212, and a battery backup system 213.

The step-down transformer 211 converts a higher line voltage to a lower voltage, such as 120VAC (Volts alternating current). The AC/DC converter 212 converts the stepped down voltage (e.g., 120VAC) to a lower DC voltage. The DC voltage from the AC/DC converter 212 is sent to a battery backup system 213, which provides the power for the antenna array cards 151-1 to 151-n in the card cages 208-1 to 108-n.

The battery backup system 213 is implemented because line AC power (also known as line power, AC power, wall power, or outlet power) is prone to fluctuations and/or interruptions. The battery backup 213 ensures that the fluctuations or interruptions of the line AC power do not cause disruptions in the operation of to the antenna array cards 151-1 to 151-n because power is supplied from a battery of the battery backup system 213.

In a preferred embodiment, the installation 50 further includes a backup power system 216. In the illustrated embodiment, the backup power system 216 is located in a basement of the structure 200. In alternative embodiments, the backup power system 216 is located on the roof of the structure 200, within the power supply site 209, or at the base of the structure 200, to list a few examples.

In a preferred embodiment, the backup power system 216 is generator with an automatic transfer switch (or ATS). In the event of a power failure at the installation, the ATS automatically switches to the backup power system 216 to provide power to the installation 50.

The installation 50 is supported by the structure 200. In a preferred embodiment, the structure 200 has a height H_{b} (height of building) of at least 33 feet (or about 10 meters). Additionally, the structure 200 should include the necessary rooftop rights (e.g., zoning or permitting) to allow structures on the roof that rise approximately 12 feet (approximately 4 meters) above the roof of the structure 200 (for a total height of at least 45 feet or approximately 13 meters).

In one embodiment, the weight of the cage site 205 with card cages 208-1 to 208-n is approximately 9,000 pounds (approximately 4,000 kilograms). Additionally, the power supply site 209, cooling system 206, and any accumulated snow or rain will also add weight that must be supported by the structure 200. Due to the potential weight loads of the installation 50, the structure 200 is typically a commercial office building, high-rise apartment complex, or industrial building that is designed and constructed to handle large static and dynamic weight loads. Typically, 5,000 (usable) interior square feet will support one (rooftop) cage site 205 with approximately 20 card cages 208-1 to 208-n.

The installation 50 further includes a backend site 220 that holds other portions of the system for the capture and distribution of over the air content 100. In the illustrated embodiment, the backend site 220 is located in a basement of the structure 200. Alternatively, the backend site 220 could also be a floor or ground level but located near the structure 200, for example. A data transport 214 connects the cage site 205 to the backend site 220. In the illustrated example, the data transport 214 is an N×10 GBase E optical data transport.

In a preferred embodiment, the installation 50 includes an ISP (Internet service provider) fiber optic data link 226 that connects the backend site 220 to the Internet 127. In a preferred embodiment, the ISP fiber optic data link 226 is a dual point of entry fiber optic connection. Client devices such as tablets, (e.g. iPad 128) and smartphones (e.g., iPhone 130) that have Internet connectively receive streamed content via the Internet or other public and/or private network 127.

In a preferred embodiment, the structure 200 includes an elevator 222 that accesses the roof and/or floors of the structure 200 on which the cage site 205 and backend site 220 are located. Preferably, the elevator 222 is a freight elevator.

In a preferred embodiment, the installation 50 includes lightning protection 202 on the roof of the structure to protect the cage site 205, power supply 209, and cooling system 206 from lightning strikes. In the illustrated embodiment, the lightning protection device 202 is a lightning rod connected to ground via a grounding wire 204.

Line AC power for the installation 50 is carried via power lines 236, 237. Typically, the power lines 236, 237 are carried by one or more utility poles 234, but in some locations the line AC power is carried via underground power lines. The line AC power enters the structure 200 at an entry point 238 and is transferred to the power supply site 209 via electrical wiring 241. The entry point 238 typically includes safety and metering devices such as a circuit breaker panel (or fuse box) and one or more electricity meters.

In a typical implementation, the line AC power entering the structure and the power supply site 205 is three-phase electric power with a line to line nominal voltage of at least 460 volts. The actual voltage received at the structure 200 often varies from the nominal voltage due to varying loads on the electrical grid, lightning strikes, and outages/disruptions to electrical grid, to list a few examples. Thus, the actual voltage received at the structure 200 and power supply site is typically higher or lower than the nominal voltage. In a preferred embodiment, the line AC is preferably at least 600 amps at 460VAC.

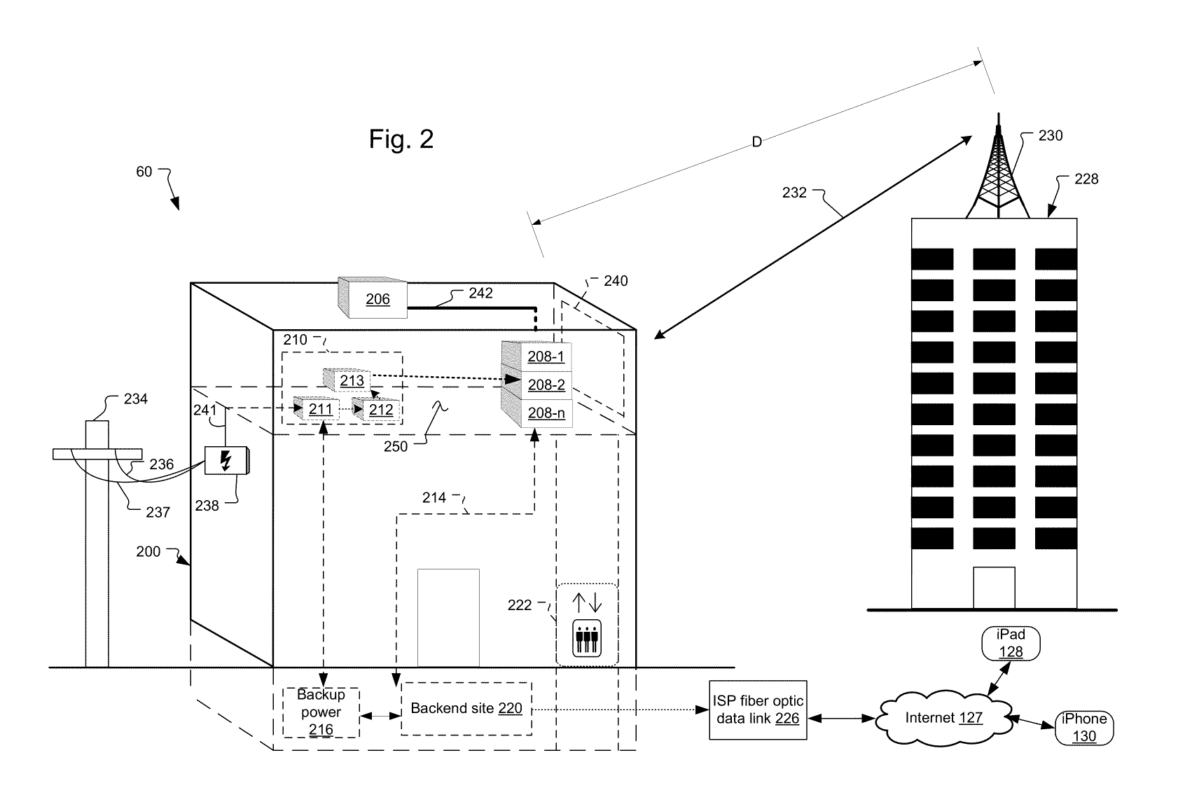

FIG. 2 is a hybrid block and schematic perspective diagram of an alternative installation 60 for high volume television broadcast capture.

In some situations it may not be possible or desirable to locate the cage site 205 and/or power supply site 209 on the roof of the structure 200 because of building codes, weather, or space limitations, for example. Thus, in an alternative embodiment the card cages 208-1 to 208-n and power supply 210 are located on a floor 250 of the structure 200. Generally, the overall operation and functionality of the installation 60 remains identical to the installation described in FIG. 1.

In the illustrated embodiment, the floor 250 of the structure 200 functions as the cage site 205 and power supply site 209 to protect the card cages 208-1 to 208-n and power supply 210.

In order to maintain the line of sight 232 to the one or more television transmitters 230, the floor 250 of the structure 200 includes at least one window 240 facing the television transmitter 230. In a preferred embodiment, there is at least 200 square feet of windows with a line of sight 232 to the one or more televisions transmitters 230. In one example, the window 240 is approximately 25 feet in length and 8 feet in height (or about eight meters by three meters). In an alternative embodiment, the floor 250 of the structure 200 has multiple windows with a combined area of at least 200 square feet.

Generally, the windows should not include Low-E (or Low-emittance) glass because this glass includes materials and/or coatings that are able to reflect and/or absorb the radio frequency signals from the television transmitters.

Additionally, similar to the installation described in FIG. 1, the floor 250 of the structure 200 is at least 33 feet (approximately 10 meters) above the ground.

In the illustrated embodiment, the cooling system 206 remains on the roof of the structure 200. In this embodiment chiller pipes or ductwork 242 connected to cooling system 206 to the room 250. Alternatively, the cooling system 206 could also be located within the floor 250 or in a basement of the structure 200.

FIG. 3 is a schematic perspective view of an exemplary card cage 208, which is shown in phantom. The card cage 208 functions as an enclosure to house the antenna array cards 151-1 to 151-n to create a three-dimensional array of antenna elements. The three dimensional array is comprised of multiple two dimensional antenna arrays 103-1 to 103-n.

The sides, top, bottom and front walls of the card cage 208 are fabricated from a conductive material to maximize Faraday shielding of the antenna elements from the active electronics. The front wall of the card cage provides an open port as the boresight of the antenna arrays 103-1 to 103-n and faces the television transmitters 230. The rear wall includes data transport interfaces that connect the antenna array cards 151-1 to 151-n to the backend site 220 via the data transport 214.

In general, each antenna array card 151-1 to 151-n includes three sections. The first section is the antenna array 103-1 to 103-n. The second section is the tuner and demodulator section 111-1 to 101-n. The third section is the data transport section 107-1 to 107-n.

In a current embodiment, each antenna array 103-1 to 103-n includes 80 antenna elements that are located outside the Faraday shielding of the card cage 208. Typically, the antenna elements are dual loop antennas. Thus, in the current embodiment with 80 antenna elements, there are 160 loop antennas. In alternative embodiments, as many as 320 antenna elements (640 loops antennas) or possibly 640 antenna elements (1280 loops antennas) are installed on each antenna array card 151-1 to 151-n. Each antenna is approximately 0.5 inches in height, 0.5 inches wide, or about 1 centimeter (cm) by 1 cm, and has a thickness of approximately 0.030 inches, or about a 1 millimeter (mm). In terms of the antenna elements, when configured as a square loop, the 3 sided length is preferably less than 1.7 inches (4.3 cm), for a total length of all 4 sides being 2.3 inches, (5.8 cm).

Air dams 109-1 to 109-n divide the antenna arrays 103-1 to 103-n from the tuner demodulator sections 111-1 to 111-n. The air dams 109-1 to 109-n act to block the airflow for the antenna array cards 151-1 to 151-n and fill in the gap between the cards such that the air dam of each card engages the backside of its adjacent card. Additionally, the air dams 109-1 to 109-n also act as part of the Faraday shields to reduce electromagnetic interference (EMI) between the tuner and demodulator sections 111-1 to 111-n and the antenna arrays 103-1 to 103-n.

Tuners 104-1 to 104-n and demodulators 106-1 to 106-n are mounted on the tuner and demodulator sections 111-1 to 111-n of the antenna array cards 151-1 to 151-n.

The tuners 104-1 to 104-n tune the antenna of the antenna arrays 103-1 to 103-n to capture over the air content broadcast by the one or more television transmitters 230. The captured over the air content (or content transmissions) are then demodulated into MPEG-2 format as content transmission data by the demodulators 106-1 to 106-n. The content transmission data from the demodulators 106-1 to 106-n are then transmitted to the data transport sections 107-1 to 107-n of each antenna array card 151-1 to 151-n. In one embodiment, the data transport sections 107-1 to 107-n include N×10 GBase E communications interfaces.

Typically, the antenna array cards 151-1 to 151-n are orientated vertically, with the antenna elements horizontal to create a horizontally polarized (Electric Field) half omni-directional antenna array. Additionally, the antenna elements protrude out of the front of card cage 208 to further help reduce interference between the components (e.g., tuner and demodulators) and the antenna arrays 103-1 to 103-n.

Alternatively, if over the air content from the broadcasters has a vertical polarization, which occurs in some locales, then orientation of the antenna array cards 151-1 to 151-n and antennas should be changed accordingly. The illustrated example shows the orientation of the antennas for broadcasters with horizontal polarization.

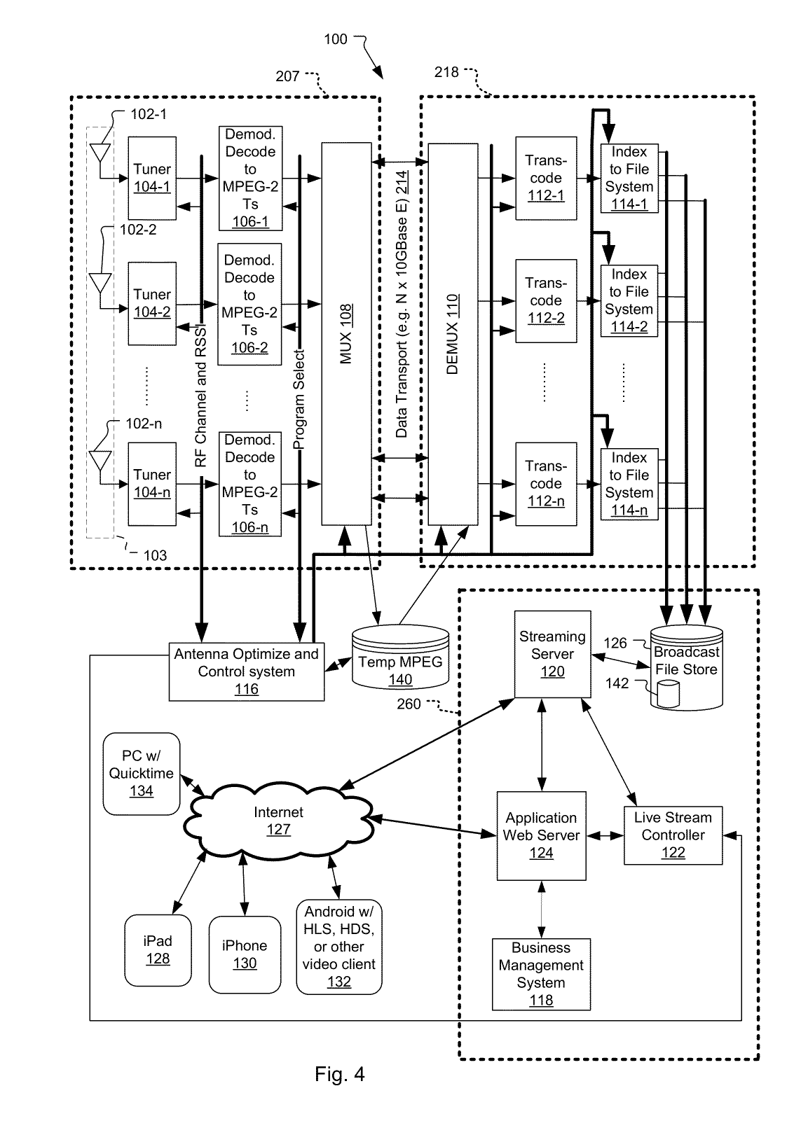

FIG. 4 is a block diagram illustrating the system for the capture and distribution of over the air content 100. Generally, the capture and distribution system 100 includes the storage, streaming, and web subsystem 260, the capture and demodulation subsystem 207, and the transcode and indexer subsystem 218.

In a typical implementation, users access the capture and distribution system 100 via the Internet 127 with client devices 128, 130, 132, 134. In one example, the client device is a personal computer 134 that accesses the capture and distribution system 100 via a browser. In other examples, the capture and distribution system 100 is accessed by mobile devices such as a tablet or slate computing device 128, e.g., iPad mobile computing device, a mobile phone 130, e.g., iPhone mobile computing device, or other mobile computing devices running the Android operating system by Google, Inc. 132. Other examples of client devices are televisions and DVD players that have network interfaces and Internet browsing capabilities. Additionally, many modern game consoles also have the ability to run third-party software and provide web browsing capabilities that can be deployed to access the video from the capture and distribution system 100 over a network connection.

The broadcast content is often displayed using HTML-5 or with a media player executing on the client devices such as QuickTime by Apple Corporation, Windows Media Player by Microsoft Corporation, iTunes by Apple Corporation, or Winamp Media Player by Nullsoft Inc., to list a few examples.

In the illustrated embodiment, the storage, streaming, and web subsystem 260 includes an application web server 124, a business management system 118, a live stream controller 122, a streaming server 120, and a broadcast file store 126. In general, the subsystem 260 handles the user the requests for content, manages the storage of the content, and controls the streaming and playback of the content.

The application web server (or application server) 124 manages requests or commands from the client devices 128, 130, 132, 134 and allows the users on the client devices 128, 130, 132, 134 to select whether they want to access previously recorded content, i.e., a television program, set up a future recording of a broadcast of a television program, or watch a live broadcast television program. In some examples, the capture and distribution system 100 also enables users to access and/or record radio (audio-only) broadcasts.

The business management system 118 verifies accounts of the users and helps set up new accounts if the users do not yet have one.

If the users request to watch previously recorded content transmissions, then the application server 124 sends the users' command to the streaming server 120 and the live stream controller 122. The live stream controller 122 locates the requested content for the users. Typically, the previously recorded content transmissions are stored in a temporary MPEG file store 140 as content transmission data or stored in a broadcast file store (or file store) 126 as content data if the content transmission data was previously transcoded.

If the previously recorded content transmissions are in the temporary MPEG file store 140 as content transmission data, then the live stream controller 122 instructs an antenna optimization and control system 116 to allocate transcoders to transcode the content transmission data. On the other hand, if the previously recorded content is stored in the file store 126 as content data, then the live stream controller 122 instructs the streaming server 120 to retrieve each users' individual copy of the previously recorded content transmission from the file store 126 and stream the content data to the client devices 128, 130, 132, 134 from which the request originated.

If the users request to set up future recordings or watch a live broadcast of content transmissions such as television programs, the application server 124 communicates with the live stream controller 122, which instructs the antenna optimization and control system 116 to configure broadcast capture resources to capture and record the desired broadcast content transmissions by reserving antenna and encoding resources for the time and date of the future recording.

On the other hand, if the users request to watch live broadcast content transmissions, then the application server 124 passes the requests to the live stream controller 122, which then instructs the antenna optimization and control system 116 locate available antenna resources ready for immediate use.

In current embodiments, streaming content is temporarily stored or buffered in the streaming server 120 and/or in a buffer 142 of the broadcast file store 126 prior to playback and streaming to the users whether for live streaming or future recording. This buffering allows users to pause and replay parts of the television program and also have the program stored to be watched again.

In one implementation, the antenna optimization and control system 116 maintains the assignment of this antenna to the user throughout any scheduled television program or continuous usage until such time as the user releases the antenna by closing the session or by the expiration of a predetermined time period as maintained by a timer implemented in the antenna optimization and control system 116. An alternative implementation would have each antenna assigned to a particular user for the user's sole usage. In an alternative implementation, users are assigned new antennas whenever the users request a different live broadcast. In this implementation, the behavior predictor 136 instructs the live stream controller 122 and the antenna optimize and control system 116 to reserve additional antennas to capture the secondary broadcast content for the users.

The capture and demodulation subsystem 207 typically includes the array of antenna elements 103, tuners 104-1 to 104-n, demodulators 106-1 to 106-n, that are implemented on the antenna array cards 151-n to 151-n within the card cages and a multiplexor 108. In general, the subsystem 207 handles the capturing and demodulation of over the air content.

The broadcast capture portion of the system 100 includes an antenna array 103 of antenna elements (e.g., 102-1 to 102-n). Each of the antenna elements 102-1 to 102-n of the array 102 is capable of capturing different over the air content from different broadcasting entities and, through a digitization and encoding pipeline, separately process those the over the air content for storage and/or live streaming to the client devices 128, 130, 132, 134. In the illustrated example, only one antenna array of antenna elements is shown.

In a typical implementation, the antenna optimization and control system 116 determines which antenna elements 102-1 to 102-n within the antenna array 102 are available and optimized to receive the particular over the air broadcast content transmissions requested by the users. In some examples, this is accomplished by comparing RSSI (received signal strength indicator) values of different antenna elements. RSSI is a measurement of the power of a received or incoming radio frequency signal. Thus, the higher the RSSI value, the stronger the received signal. In an alternative embodiment, the antenna optimization and control system 116 determines the best available antenna using Modulation Error Ratio (MER). Modulation Error Ratio is used to measure the performance of digital transmitters (or receivers) that are using digital modulation. In another alternative embodiment, a round robin algorithm is implemented to assign available antennas to users.

After locating an available antenna element, the antenna optimization and control system 116 allocates the antenna element to the user. The antenna optimization and control system 116 then signals the corresponding tuner 104-1 to 104-n to tune the allocated antenna element to receive the broadcast.

The received broadcasts from each of the antenna elements 102-1 to 102-n and their associated tuners 104-1 to 104-n are transmitted to corresponding demodulators 106-1 to 106-n to create parallel processing pipelines for each allocated antenna 102-1 to 102-n and tuner 104-1 to 104-n pair.

The demodulators 106-1 to 106-n demodulate and decode the separate content transmissions from the antenna elements 102-1 to 102-n and tuners 104-1 to 104-n into MPEG-2 format. In the illustrated embodiment, the demodulators 106-1 to 106-n are an array of ATSC (Advanced Television Systems Committee) decoders assigned to each of the processing pipelines. In a situation where each broadcast carrier signal contains multiple content transmissions, the antenna optimization and control system 116 signals the demodulators 106-1 to 106-n to select the desired program contained on the carrier signal. The content transmissions are decoded to MPEG-2 content transmission data because it is currently a standard format for the coding of moving pictures and associated audio information. In alternative embodiments, the content transmissions could be decoded into different formats that are known in the art.

The content transmission data from the demodulators 106-1 to 106-n are sent to a multiplexer 108. From the multiplexer 108 the content transmissions are transmitted across a data transport 214 to the transcode and indexer subsystem 218. In the illustrated example, the data transport 214 is an N×10 GBase E optical data transport layer.

The transcoding and indexer subsystem 218 includes a demultiplexer 110, transcoders 112-1 to 112-n and indexers 114-1 to 114-n. In general, the subsystem 218 transcodes the content transmission data into MPEG-4 format and adds time index information to the transcoded content transmission data.

The content transmission data of each of the antenna processing pipelines are transcoded into a format that is more efficient for storage and streaming. In the current implementation, the transcode to the MPEG-4 (also known as H.264) format is effected by an array of transcoders 112-1 to 112-n. Typically, multiple transcoding threads run on a single signal processing core, SOC (system on a chip), FPGA or ASIC type device.

In a typical implementation, at least some content transmission data are transcoded offline and during off-peak hours when the demands on the system resources are lowest and when the content transmission data are not required for real-time viewing by the users. The antenna optimization and control system 116 directs the content transmission data from the multiplexor 108 to the temporary MPEG file store 140 if transcoder usage exceeds a threshold, in one implementation. Generally, the threshold is based on the availability and usage of the transcoders 112-1 to 112-n. The antenna optimization and control system 116 later instructs the transcoders 112-1 to 112-n to transcode the content transmission data stored in the temporary MPEG file store 140. This system configuration enables a smaller number of transcoders to handle user requests because many users do not watch live streaming content.

In alternative embodiments, the antenna optimization and control system 116 directs the majority of the content transmission data to the temporary MPEG file store 140 to further reduce the workload of the transcoders 112-1 to 112-n and enable the antenna optimization and control system 116 to more efficiently schedule transcoding resources. Again, this can only happen for the content transmissions that are not required in real-time by the users.

The content transmission data are transcoded to MPEG-4 format to reduce the bitrates and the sizes of the data footprints. As a consequence, the conversion of the content transmission data to MPEG-4 encoding will reduce the picture quality or resolution of the content, but this reduction is generally not enough to be noticeable for the average user on a typical reduced resolution video display device. The reduced size of the content transmissions will make the content transmissions easier to store, transfer, and stream to the user devices. Similarly, audio is transcoded to AAC in the current embodiment, which is known to be highly efficient.

In one embodiment, the transcoded content transmission data are sent to a packetizers and indexers 114-1 to 114-n of the pipelines, which packetize the data. In the current embodiment, the packet protocol is UDP (user datagram protocol), which is a stateless, streaming protocol. UDP is a simple transmission model that provides less reliable service because datagrams may arrive out of order, duplicated, and go missing. Generally, this protocol is preferred for time-sensitive transmission, such as streaming files, where missing or duplicated packets can be dropped and there is no need to wait for delayed packets.

Also, in this process, time index information is added to the content data. The content data are then transferred to the broadcast file store 126 for storage to the file system, which is used to store and/or buffer the content transmissions as content data for the various content transmission, e.g., television programs, being captured by the users. In an alternative embodiment, the indexers are part of the storage, streaming, and web subsystem 260.

In typical embodiments, the content data are streamed to the users with HTTP Live Streaming or HTTP Dynamic Streaming. These are streaming protocols that are dependent upon the client device. HTTP Live Streaming is a HTTP-based media streaming communications protocol implemented by Apple Inc. as part of its QuickTime X and iPhone software systems and by others such as GoogleTV by Google Inc. The stream is divided into a sequence of HTTP-based file downloads. HDS over TCP/IP is another option. This is an adaptive streaming a communications protocol by Adobe System Inc. HDS dynamically switches between streams of different quality based on the network bandwidth and the computing device's resources. Generally, the content data are streamed using Hypertext Transfer Protocol (HTTP) or Hypertext Transfer Protocol Secure (or HTTPS). HTTPS combines HTTP with the security of Transport Layer Security/Secure Sockets Layer (or TLS/SSL). TLS and SSL are security protocols that provide encryption of data transferred over the Internet.

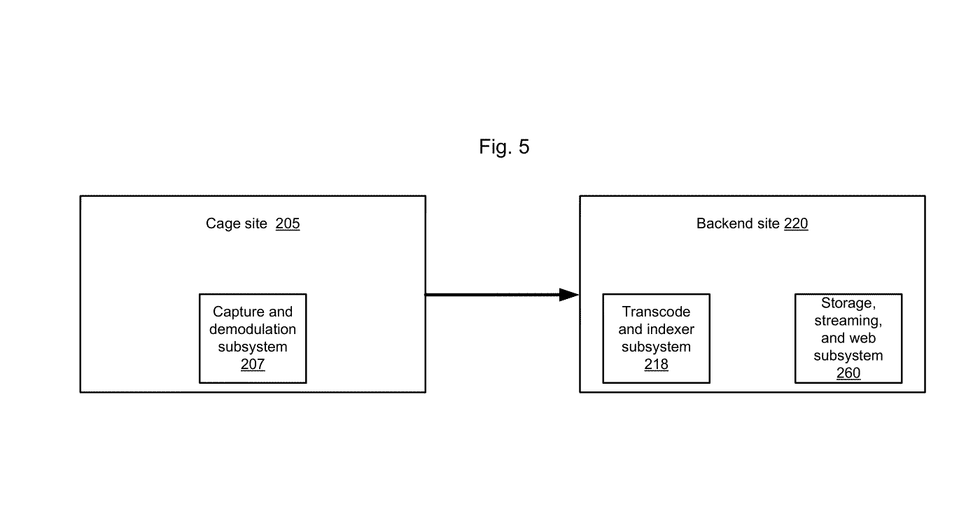

FIG. 5 is a block diagram illustrating how the capture and demodulation subsystem 207, transcode and indexer subsystem 218, and storage, streaming, and web subsystem 260 are distributed about the installations described in FIGS. 1 and 2.

In the illustrated embodiment, the capture and demodulation subsystem 208 is located at cage site 205. The transcode and indexer subsystem 218 and the storage, streaming, and web subsystem 260 is located at the backend site 220.

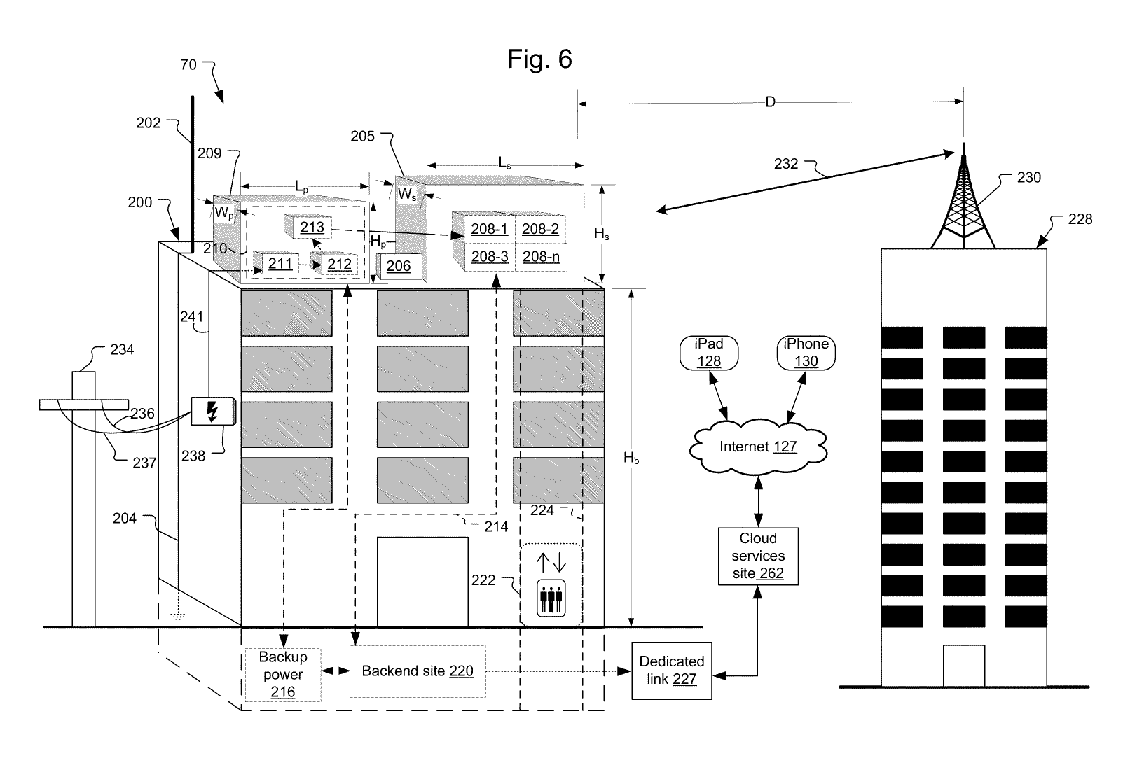

FIG. 6 is a hybrid block and schematic perspective diagram of an alternative embodiment of an installation 70 for high volume television broadcast capture that includes a cloud services site 262.

The functionality and operation of the installation 70 is similar to the installation described in FIG. 1. However, in this embodiment, the storage, streaming, and web subsystem 260 is located at the cloud services site 262. Typically, the cloud services site 262 is a server farm, data center, or content delivery network to list a few examples. Additionally, the cloud services site 262 is generally located offsite from the installation 70.

In a typical implementation, the installation 70 is connected to the cloud services site 262 via a dedicated link 227 (also known as a leased line or private line). Dedicated links are telecommunications lines that only carry network traffic of a single business or company and generally have a specific guaranteed bandwidth, which results in faster and more consistent data transfer speeds.

Often this configuration is practical for smaller installations and/or installation with limited space because the storage, streaming, and web subsystem 260 are located offsite at the cloud services site 262.

While FIG. 6 illustrates an example of an installation located on the roof of the structure 200, an embodiment that utilizes the cloud services site 262 could also be implemented when the installation is located within the structure 200 (e.g., similar to the embodiment shown of FIG. 2).

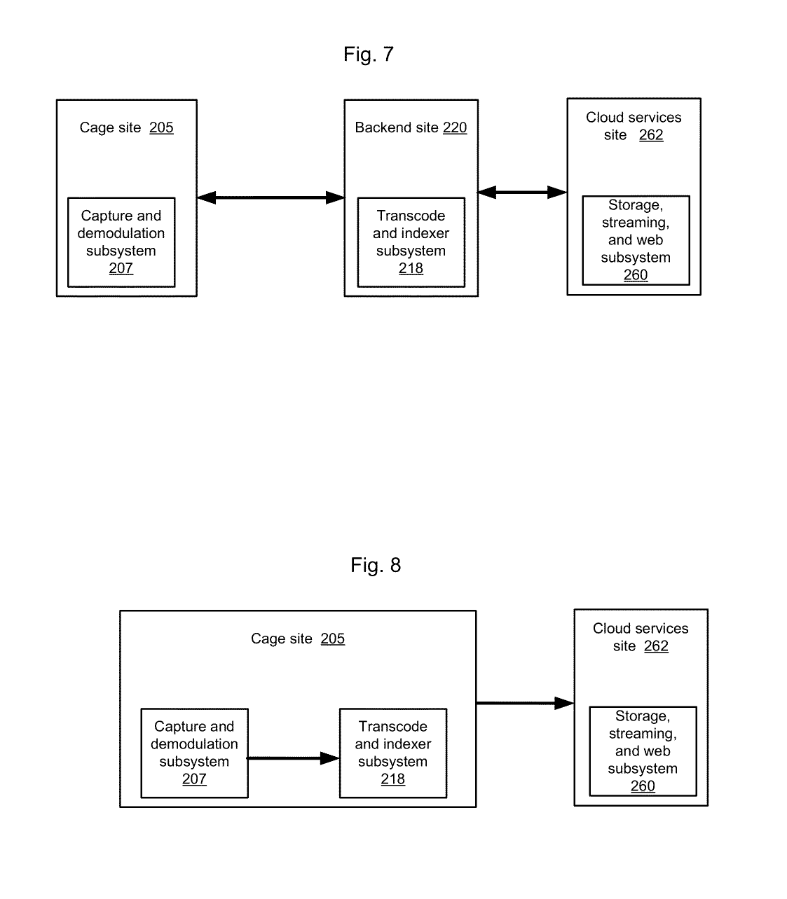

FIG. 7 is a block diagram illustrating an embodiment of how the capture and demodulation subsystem 207, transcode and indexer subsystem 218, and storage, streaming, and web subsystem 260 are distributed about the installation and the cloud services site 262 described in FIG. 6.

In the illustrated embodiment, the capture and demodulation sub system 208 is located at the cage site 205. The transcode and indexer subsystem 218 is located at the backend site 220. The storage, streaming, and web subsystem 260 is located in the cloud services site 262.

FIG. 8 is a block diagram illustrating an embodiment of how the capture and demodulation subsystem 207, transcode and indexer subsystem 218, and storage, streaming, and web subsystem 260 are distributed about the installation and the cloud services site described in FIG. 6.

In the illustrated embodiment, the capture and demodulation subsystem 208 and the transcode and indexer subsystem 218 are located at the cage site 205. The storage, streaming, and web subsystem 260 is located in the cloud services site 262.

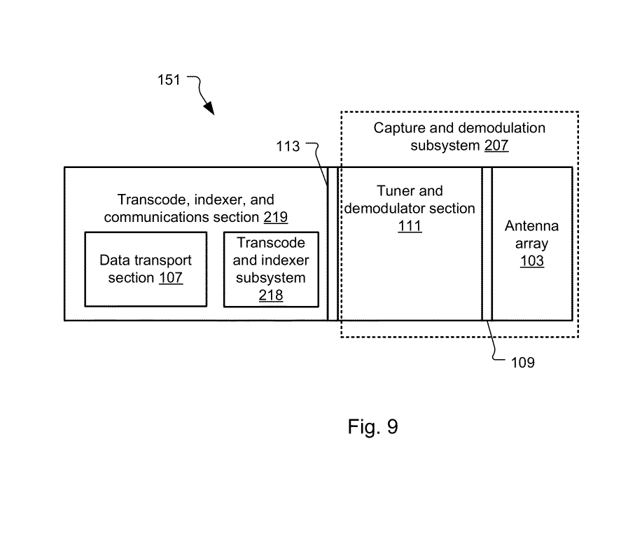

FIG. 9 is a block diagram of an alternative antenna array card 151. The antenna array card of the illustrated embodiment is similar to the antenna array card described in FIG. 3.

In the illustrated embodiment, the antenna array card 151 has a capture and demodulation subsystem, which includes an antenna array 103, an air dam 109, and a tuner and demodulator section 111. Additionally, the antenna elements of the antenna array 103 and the tuners and demodulators in the tuner demodulator section 111 function identical to the previous embodiment described in FIG. 3.

The antenna array card of the illustrated embodiment further includes a transcode, indexer, and communications section 219 and a tuner/transcoder EMI shield 113.

In a typical implementation, demodulated content transmission data are transferred to the transcode and indexer subsystem 218 of the transcode, indexer, and communications section 219 to be transcoded and indexed which is located on the antenna array card 151.

The transcoded content transmission data is then transferred to the data transport section 107, which include N×10 GBase E communications interfaces.

The tuner/transcoder EMI shield 113 separates the demodulator section 111 and the transcode, indexer, and communications section 219 and helps to prevent EMI interference generated by the transcode and indexer subsystem from affecting the tuner and demodulator section and the antenna array 103.

While this invention has been particularly shown and described with references to preferred embodiments thereof, it will be understood by those skilled in the art that various changes in form and details may be made therein without departing from the scope of the invention encompassed by the appended claims.

What is claimed is:

1. An installation for high volume television broadcast capture, comprising:
one or more card cages, each holding antenna array cards that capture television broadcasts transmitted by one or more broadcasting entities;
a cage site for protecting the one or more card cages; and
a structure supporting the cage site with the one or more card cages having a line of sight to one or more transmitters of the one or more broadcasting entities.

2. The installation according to claim 1, further comprising a cooling system to remove heat from the cage site.

3. The installation according to claim 1, further comprising a power supply that converts line AC power entering the structure to DC power for the antenna array cards.

4. The installation according to claim 3, wherein the power supply includes a stepdown transformer that converts the line AC power entering the structure to a lower voltage and a battery backup that provides DC power to the antenna array cards if the AC line power fails.

5. The installation according to claim 3, wherein the line AC power entering the structure is three-phase electric power.

6. The installation according to claim 4, wherein the three-phase electric power has a line to line nominal voltage of at least 460 volts.

7. The installation according to claim 3, further comprising a backup power system to provide power to the power supply if the line AC power entering the structure fails.

8. The installation according to claim 3, further comprising a power supply site to protect the power supply.

9. The installation according to claim 1, wherein the structure is at least 10 meters tall and capable of supporting a weight load of at least 4,000 kilograms.

10. The installation according to claim 1, wherein a range from the cage site to the one or more transmitters is less than 16 kilometers.

11. The installation according to claim 1, further comprising a lightning protection device for the cage site.

12. The installation according to claim 11, wherein the lightning protection device is a conductive lightning rod that extends above the cage site and is connected to ground via a conductive wire.

13. The installation according to claim 1, wherein the structure includes an elevator that accesses a floor of the structure on which the cage site is located.

14. The installation according to claim 1, wherein the cage site has an at least 6 meter long wide side, 3 meter long depth side, and 3 meter height.

15. The installation according to claim 14, wherein the wide side of the cage site faces the transmitters of the broadcasting entities.

16. The installation according to claim 1, wherein antenna array cards provide the captured television broadcast to transcoders and storage devices located in a basement of the structure that transcode the captured television broadcasts and store the transcoded television broadcasts.

17. The installation according to claim 16, further comprising an optical fiber data link that provides an optical data transport layer between the transcoders and antenna array cards, the optical fiber data link running from the cage site, through the structure, to the basement of the structure.

18. The installation according to claim 17, further comprising a fiber optic leased line that transmits the transcoded television broadcasts from the storage devices located in the basement of the structure to a communications network of a service provider.

19. The installation according to claim 1, wherein the cage site is a box-like shelter installed on a roof of the structure.

20. The installation according to claim 1, wherein the cage site is a room located on an internal floor of the structure.

21. The installation according to claim 1, further comprising an electromagnetic interference shield to protect the cage site from electromagnetic interference.

22. A capture and distribution system, comprising:
a capture and demodulation subsystem that captures over the air content and demodulates the captured over the air content into content transmission data;
a transcode subsystem to transcode the content transmission data;
a cloud system implementing a storage, streaming, and web subsystem to store the transcoded content transmission data and stream the transcoded content transmission data to client devices as content data; and
a data connection to transport the transcoded content transmission data to the storage, streaming, and web subsystem.

23. An antenna array card, comprising:
an antenna array for capturing over the air content;
a tuner and demodulator section for tuning antenna elements of the antenna array and then demodulating the over the air content captured by the antenna array into content transmission data; and
a transcode section for transcoding the demodulated content transmission data.

24. A method for installing a high volume television broadcast capture and distribution system, comprising:
providing one or more card cages, each holding antenna array cards that capture television broadcasts transmitted by one or more broadcasting entities;
installing the card cages in a cage site that protects the one or more card cages; and
supporting the cage site with the one or more card cages at a location that provides a line of sight to one or more transmitters of the one or more broadcasting entities.

25. The method according to claim 24, further comprising removing heat from the cage site with a cooling system.

26. The method according to claim 24, further comprising installing a backup power system at the location to provide power if line AC power fails.

27. The method according to claim 24, further comprising locating the cage site less than 16 kilometers from the one or more television transmitters.

28. The method according to claim 24, further comprising protecting the cage site from electromagnetic interference with an electromagnetic interference shield.

29. A method for television capture and distribution, comprising:
capturing over the air content and demodulating the captured over the air content into content transmission data;
transcoding the content transmission data;
transporting the transcoded content transmission data to a cloud system;
storing and streaming the transcoded content transmission data to client devices from the cloud system.
